(19) United States
(12) Patent Application Publication
(10) Pub. No.: US 2007/0240104 A1
(43) Pub. Date: Oct. 11, 2007

(54) System and method for validating common information model (CIM) compliance

(75) Inventors: Linda Martinez, Pflugerville, TX (US); RadhaKrishna Reddy Dasari, Round Rock, TX (US); Nathan R. Rakoff, Round Rock, TX (US); Jianwen Yin, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/401,057

(22) Filed: Apr. 10, 2006

(51) Int. Cl. G06F 9/44

(52) U.S. Cl. 717/104

(57) ABSTRACT

A method of verifying compliance with a Common Information Model (CIM) includes accessing a CIM metadata file and information indicative of a revised CIM Schema and using the accessed information to produce a revised CIM metadata file. The revised metadata file includes information indicative of CIM components associated with a CIM implementation. The CIM components may include the particular CIM Schema, CIM provider, and CIM profile used. The metadata file may be an XML file and may indicate extension classes associated with the CIM implementation and corresponding CIM Schema defined parent classes. The method may also include providing the revised metadata file to a validation engine having access to information indicative of CIM extension classes indicated in the revised metadata file and CIM Schema classes, and generating a compliant/non compliant signal indicative of whether the CIM implementation is CIM compliant.

### TECHNICAL FIELD

The present invention is in the field of computer systems and, more particularly, management of computer systems according to a standardized specification.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a server, which is a processor-based network device that manages network resources. As examples, a file server is dedicated to storing files, a print server manages one or more printers, a network server manages network traffic, and a database server processes database queries.

The total cost of ownership associated with an information handling system in general and server system particularly is affected by the server's system management facilities. In general, system management facilities refer to software, hardware, and/or firmware that enables remote or automated execution of administrative tasks such as powering on, powering off, updating firmware, deploying applications, monitoring status, monitoring alerts, and so forth. The cost saving implications of systems management facilities have resulted in a great deal of emphasis being placed on systems management in recent years.

Part of the effort regarding systems management has been standardization and, more specifically, providing a complete and standardized model of an information handling system to which all vendors and developers could adhere in the design of systems management facilities and applications. The Common Information Model (CIM) is a product of this effort from the Distributed Management Task Force (DMTF). CIM has been adopted by many large vendors of systems, software, and management services including Dell, Hewlett Packard, IBM, Intel, and Microsoft thereby making CIM the most pervasive system management standard.

The DMTF describes CIM as a conceptual information model for describing management that is not bound to a particular implementation. CIM allows for the interchange of management information between management systems and applications. CIM attempts to define and organize common and consistent semantics for networking and computing equipment, and services. CIM data organization is object-oriented, supporting the concepts of inheritance, relationships, abstraction, and encapsulation to improve the quality and consistency of management data.

CIM encompasses a CIM Infrastructure Specification (also referred to simply as the CIM Specification) and a CIM Schema. Both are published electronically on the DTMF web site (http://www.dmtf.org/standards/cim) and are incorporated by reference herein. The CIM Infrastructure Specification includes a formal definition of the model and describes the language, naming, and mapping techniques to other management models such as SNMP MIBs, and DMTF MIFs etc.

The CIM Schema provides the actual model descriptions. The CIM Schema supplies a set of classes with properties and associations that provide a well-understood conceptual framework within which it is possible to organize the available information about the managed environment. The formal definition of the CIM Schema is expressed in a Managed Object File (MOF) which is an ASCII or UNICODE file that can be used as input into a MOF editor, parser, or compiler for use in an application.

The CIM Schema includes three layers, namely, the Core Schema, the Common Schema, and the Extension Schema. The Core Schema is an information model that captures notions that are applicable to all areas of management. Common Schemas are information models that capture notions that are common to particular management areas, but independent of a particular technology or implementation. Examples of common areas are systems, devices, networks, applications, and so forth. Models for these common areas define classes addressing each of the management areas in a vendor-neutral manner. Extension Schemas, in contrast, represent organizational or vendor-specific extensions of the Common Schema. Extension Schemas can be specific to environments, such as operating systems (for example, UNIX® or Microsoft Windows®.

A CIM profile, which may be specified in documents published by the DMTF or in specifications created by other organizations, defines the CIM model and associated behavior for a particular management domain implementation (including the CIM classes, associations, indications, methods and properties). A profile provides a unified way of describing the management domain in CIM.

The CIM standard covers almost every aspect of a computer system including: hardware devices, peripherals, drivers, event indications, services, and their relationships. Unfortunately, CIM is a rapidly evolving standard and there are significant changes with every new version of the CIM standard. The rapid evolution of CIM and the frequency of substantial revisions to CIM amplify problems, described below, that currently exist when trying to implement a CIM compliant system or solution.

CIM lacks a data definition standard establishing a clear connection between the vital components of a CIM standard implementation. There is no explicitly specified relationship linking the CIM profile, CIM provider, and CIM Schema that correspond to a particular implementation (as expressed in an Extension MOF). The lack of a link between the CIM profile and the CIM Schema used as the basis for an Extension MOF has significant implications for systems manufacturers and applications developers.

For example, the CIM Schema does not contain all of the information needed to be compliant with the CIM Profiles. Similarly, it is difficult for a developer to determine the requirements for compliance from a MOF generated from the CIM Schema. Moreover, performing version control on the CIM Schema is difficult. When a new version of the CIM Schema is introduced, the extension classes and properties defined in an existing profile must be manually verified for compliance with the new schema. There is no automated process to verify the compliance of the customized MOF with the CIM Schema and CIM Profiles.

### SUMMARY OF THE INVENTION

Therefore a need has arisen for a method and system for providing a data structure and format identifying the specific CIM components and extensions classes on which an extension MOF is based and for using the defined data structure to facilitate the CIM compliance process when one or more CIM components are revised.

In one aspect, a method for verifying compliance with a Common Information Model (CIM) includes accessing a CIM metadata file and information indicative of a revised CIM Schema and using the accessed information to produce a revised CIM metadata file. The revised CIM metadata file includes information indicative of CIM components associated with a CIM implementation. The CIM components may include the particular CIM Schema, CIM provider, and CIM profile used in the implementation. The CIM metadata file may be an XML file and may indicate extension classes associated with the CIM implementation and CIM Schema defined parent classes corresponding to each of the extension classes. The method may also include providing the revised metadata file to a validation engine having access to information indicative of CIM extension classes indicated in the revised metadata file and CIM Schema classes, and generating a compliant/non compliant signal indicative of whether the CIM implementation is CIM compliant.

In another aspect, an information handling system configured to verify compliance with a Common Information Model (CIM) includes a CIM update engine for accessing a CIM metadata file and information indicative of a revised CIM Schema and using the accessed information to produce a revised CIM metadata file. The revised metadata file includes information indicative of CIM components associated with a CIM implementation. The CIM components may include the particular CIM Schema, CIM provider, and CIM profile used. The metadata file may be an XML file and may indicate extension classes associated with the CIM implementation and corresponding CIM Schema defined parent classes. The system may also include a CIM validate engine to provide the revised metadata file to a validation engine having access to information indicative of CIM extension classes indicated in the revised metadata file and CIM Schema classes, and generating a compliant/non compliant signal indicative of whether the CIM implementation is CIM compliant.

In yet another aspect, a computer readable medium having embedded instructions for verifying compliance with a Common Information Model (CIM) includes instructions for accessing a CIM metadata file and information indicative of a revised CIM Schema and instructions for using the accessed information to produce a revised CIM metadata file. The revised metadata file includes information indicative of CIM components associated with a CIM implementation. The CIM components may include the particular CIM Schema, CIM provider, and CIM profile used. The metadata file may be an XML file and may indicate extension classes associated with the CIM implementation and corresponding CIM Schema defined parent classes. The media may also include instructions for providing the revised metadata file to a validation engine having access to information indicative of CIM extension classes indicated in the revised metadata file and CIM Schema classes, and instructions for generating a compliant/non compliant signal indicative of whether the CIM implementation is CIM compliant.

A number of important technical advantages are described herein. One technical advantage is the ability to maintain and verify compliance to CIM standards as the CIM components are revised or otherwise evolved. Additional advantages will be apparent to those of skill in the art and from the FIGURES, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a conceptual illustration of a system and method for migrating a CIM metadata file to a new CIM metadata file based on a new version of the CIM Schema and/or Profiles;

FIG. 2 is an exemplary illustration of the CIM metadata file of FIG. 1;

FIG. 3 is an abstracted representation of selected elements of the CIM metadata file of FIG. 2;

FIG. 4 is a conceptual illustration of a system and method for validating the compliance of a CIM implementation using the CIM metadata file of FIG. 1; and

FIG. 5 is a flow diagram of an embodiment of the validating method of FIG. 4.

### DETAILED DESCRIPTION OF THE INVENTION

Preferred embodiments of the invention and its advantages are best understood by reference to the drawings wherein like numbers refer to like and corresponding parts.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

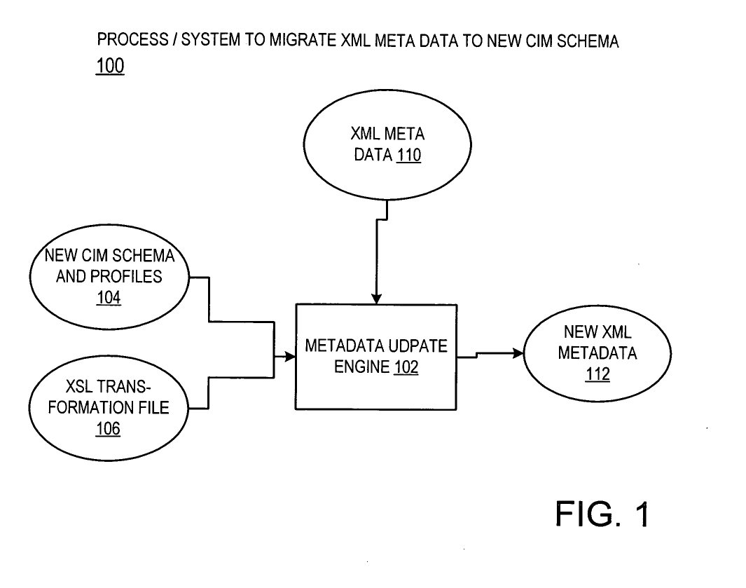

Preferred embodiments and their advantages are best understood by reference to FIG. 1 through FIG. 5, wherein like numbers are used to indicate like and corresponding parts. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In one aspect, a data structure and a system and method for using the structure are described that facilitate the process of validating the CIM compliance of a particular CIM implementation. The data structure is preferably an XML file that contains CIM metadata indicative of the CIM components associated with a corresponding CIM implementation. The CIM components identified in the CIM metadata file would preferably include the CIM Schema, the CIM provider, the CIM profile, and any defined extension classes. One application of the described data structure includes a process for updating the defined CIM metadata file following a change or revision in one or more of the CIM components associated with a particular CIM implementation. Another application includes using the defined CIM metadata file in an automated process for verifying the CIM compliance of a particular CIM implementation.

Referring now to FIG. 1, a conceptual representation of an information handling system and procedure 100 for generating an updated CIM metadata file in response to a revision in the CIM Schema and/or the CIM profiles is described. As depicted in FIG. 1, a metadata update engine 102 generates a new CIM metadata file 112 from an existing CIM metadata file 110 following a revision in the standard CIM Schema and/or profiles, which are collectively represented in FIG. 1 by reference numeral 104. CIM metadata files 110, 112 provide a structure and format for data that establishes a connection between the vital components of a customer's CIM implementation. CIM metadata file 110 preferably provides a link among a specific CIM provider, a specific collection of CIM profiles, and a particular version of the CIM schema.

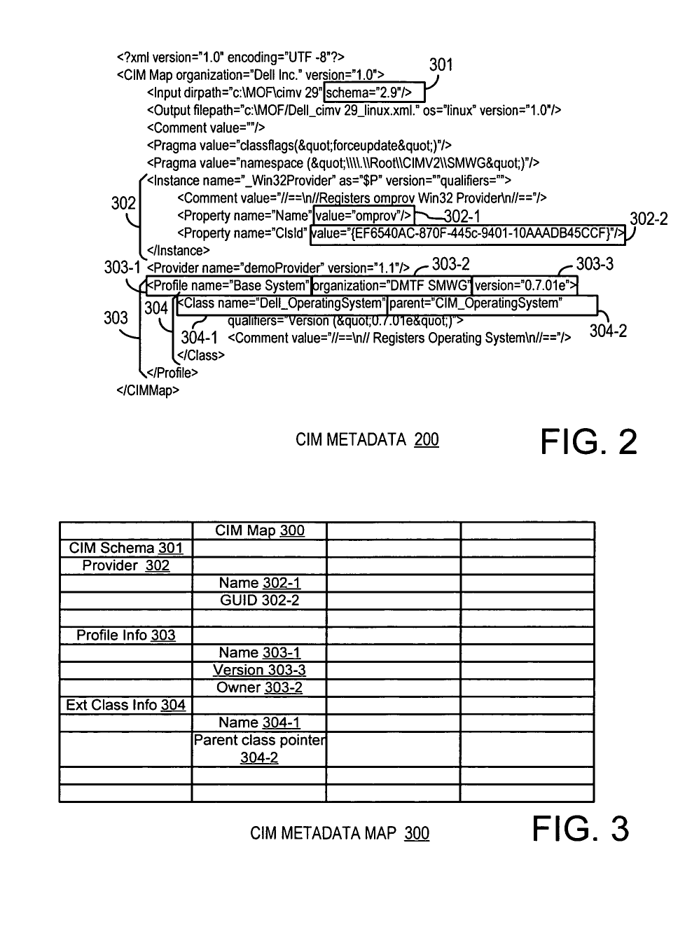

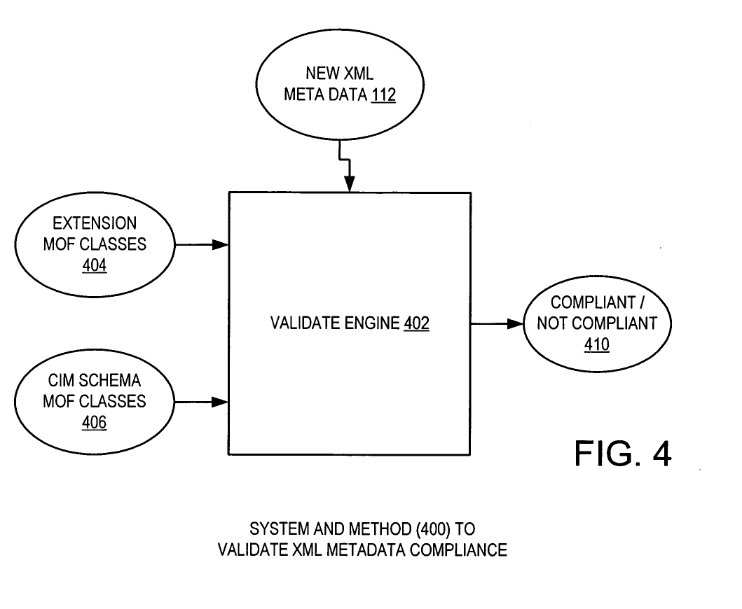

CIM metadata files 110, 112 preferably include CIM schema information, provider information, and profile information. Referring to an exemplary CIM metadata file depicted in FIG. 2 and a conceptual abstraction of the exemplary CIM metadata file depicted in FIG. 3, the depicted embodiment of CIM metadata file 300, which is suitable for use as CIM metadata files 110 and 112 in FIG. 1, is an XML file that includes a CIM Schema indicator 301, provider information 302, and profile information 303. Provider information 302 includes a provider name 302-1 and a globally unique identifier (GUID) 302-2. Profile information 303 includes a profile name 303-1, a profile version 303-2, and a profile organization 303-3. In addition, CIM metadata file 300 as depicted in FIG. 3 and FIG. 4 includes an extension class list 304 that enumerates each extension class 304-1 in the implemented profile and a parent class pointer 304-2. The parent class pointer 304-2 identifies a CIM schema standard class from which the extension class 304-1 is descended.

The CIM compliance methodology described herein recommends that vendors use vendor-specific extension classes derived from CIM standard classes, rather than using the CIM standard classes themselves. For example, instead of using the CIM_Fan class in a profile, a vendor should define its own fan class, e.g., Vendor_Fan, that is derived from CIM_Fan. This recommendation will help to preserve the class hierarchy defined by the CIM schema. Vendors can address specific class attribute and method needs in the vendor defined classes, making sure that the attributes and method do not conflict with the CIM schema. In cases where there are no changes to the attributes or methods of a standard class, the corresponding vendor specific class is derived trivially, meaning that the vendor specific class inherits all the attributes and method from its inheritance hierarchy.

Returning to FIG. 1, metadata update engine 102 is configured to apply the XSL Transformation (XSLT) codified in XSL Transformation file 106 to the old XML metadata filed 110 based on the new CIM Schema and Profiles 104. XSLT is a language that can be used to transform XML documents into other XML documents. XSLT is suitable for adding/removing elements and attributes to or from an output file. A common way to describe the XSLT transformation process is to say that XSLT transforms an XML source-tree into an XML result-tree. XSLT file 106 includes templates that specify how each node of old XML document 110 should appear in new XML document 112.

Metadata update engine 102 is configured to parse schema-dependent and profile-dependent information in XML metadata file 110. Metadata update engine 102 is further configured to use the parsed information to retrieve updated schema and profile information from CIM Schema and Profile information 104. Transformation engine 102 then accesses XSLT file 106 to create New XML metadata file 112 containing the updated Schema-specific and profile-specific information. As a simple example, metadata file 110 includes a schema attribute (reference numeral 301 on FIG. 2) identifying a CIM schema version. Update engine 102 will access New CIM and Profile information 104 to obtain a version number of the new schema and insert the new version number as an attribute in New XML metadata file 112. Similarly, metadata update engine 102 will include in new XML metadata file 112 updated profile(s) information, required class information, and GUID information.

Turning now to FIG. 4, a block diagram illustrating selected elements of a system and method 400 for validating the CIM compliance of a CIM implementation described by an XML metadata file such as the new XML metadata file 112 depicted in FIG. 1. As depicted in FIG. 4, compliance validation system 400 includes a validation engine 402 that receives CIM related input from three sources and produces a Boolean signal indicating whether the implementation described by the XML metadata file is CIM compliant.

As depicted in FIG. 4, validation engine 402 receives input in the form of Extension MOF classes 404, CIM schema MOF files, and a NEW XML metadata file 112. In one aspect, validation engine is configured to parse information from XML metadata file 112 and use it to validate that the CIM implementation described in XML metadata file 112 is CIM compliant.

Some embodiments of the invention may be implemented as a set or sequence of computer executable instructions (software), stored on a computer readable medium. In these embodiments, the software may be stored on a volatile storage medium such as system memory or in a persistent storage medium such as a hard disk, floppy disk, CD ROM, DVD, and the like. When executed by a suitable microprocessor-based information handling system, the software is configured to generate a Boolean result indicative of the CIM compliance of a CIM implementation described by the CIM metadata file.

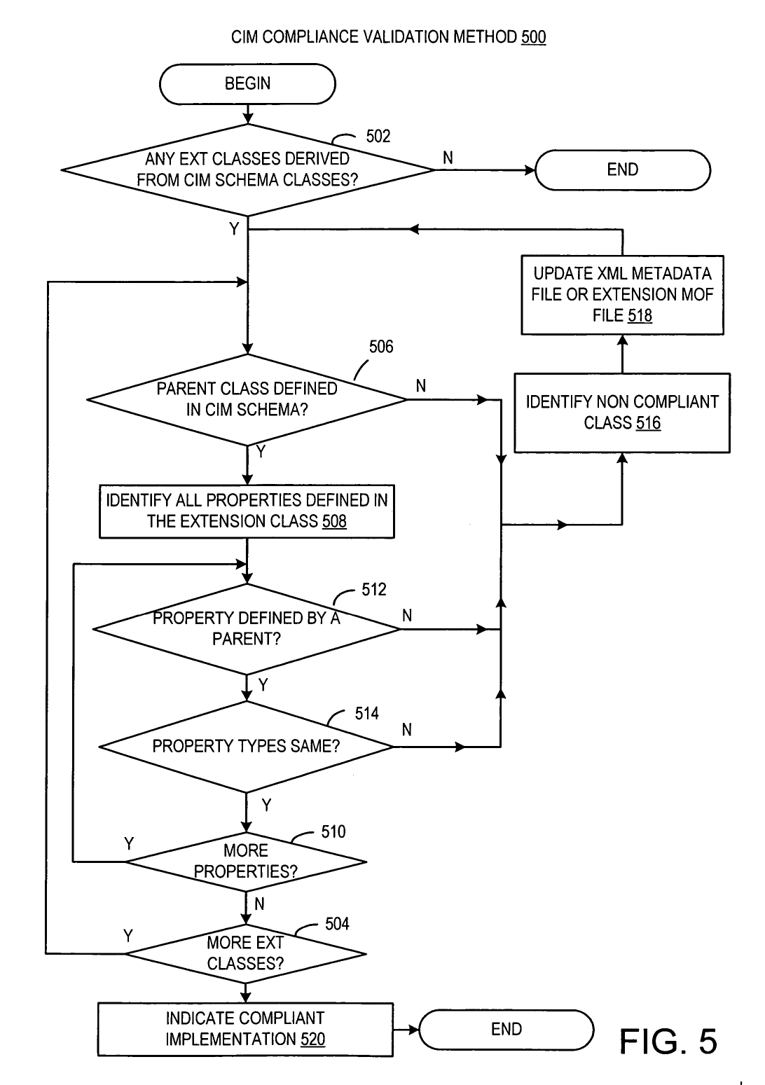

As referred to in the preceding paragraphs, XML metadata files including XML metadata files 110, 112, and 300 have sufficient information to identify the most significant details of a CIM implementation uniquely. System 400 is configured to execute a method, depicted in FIG. 5, for validating the CIM implementation described in metadata file 110. As depicted in FIG. 5, CIM validation method 500 includes first determining (block 502) whether a metadata file reflects the use of one or more extension classes derived from a CIM standard class. If a metadata file does not identify any extension classes, the depicted embodiment of validation method 500 terminates with a message indicating that no extension classes were found. As referred to previously, extension classes are preferred to CIM standard classes and block 502 provides an enforcement mechanism that requires developers and others to use extension classes instead of standard classes.

If one or more extension classes are found in block 502, the depicted embodiment of method 500 executes a loop that includes blocks 506, 508, 512, 514, once for each extension class as determined by block 504. In block 506, method 500 includes determining, for a given extension class, whether the parent class to which the extension class points is defined in the CIM Schema. If method 500 determines in block 506 that the CIM Schema does not define a parent class that is identified by an extension class, the depicted embodiment of method 500 concludes that the CIM implementation described by the XML metadata file is non compliant. Specifically, method 500 will then attempt to identify (block 516) the class that is non compliant and then update (block 518) or otherwise correct the XML metadata file or an extension managed object format (MOF) file before returning to block 506 to retry.

If every parent class pointed to or identified by an extension class listed in the XML metadata file is defined in a CIM schema, method 500 then identifies (block 508) all of the properties defined by an extension class and executes a loop, containing blocks 512 and 514, in which method 500 determines (block 512) whether a property defined in an extension class is also defined in a parent class of the extension class and, if so, then determining (block 514) whether the property type defined in the extension class differs from the type of the corresponding property.

If either block 512 or block 514 returns a negative response, meaning that an undefined or type-mismatched property is associated with an extension class identified in the metadata file, method 500 includes identifying the non compliant class (block 516) and updating (block 518) the XML metadata file or extension MOF file. If method 500 successfully verifies (block 506) each extension class and each property (block 512, 514), method 500 terminates successfully and generates (block 520) a compliant signal indicating that the CIM metadata file describes an implementation that is compliant with the CIM specification.

Although the disclosed embodiments have been described in detail, it should be understood that various changes, substitutions and alterations can be made to the embodiments without departing from their spirit and scope

What is claimed is:

1. A method of verifying and maintaining compliance with a Common Information Model (CIM), comprising accessing an existing CIM metadata file and information indicative of a revised CIM Schema and using the accessed information to produce a revised CIM metadata file, wherein the revised CIM metadata file includes information indicative of CIM components associated with a CIM implementation.

2. The method of claim 1, wherein the CIM components include a specified version of a CIM Schema, a specified CIM provider, and a specified CIM profile.

3. The method of claim 2, wherein the CIM metadata file comprises an XML file.

4. The method of claim 3, wherein the CIM metadata file further includes information indicative of extension classes associated with the CIM implementation and parent classes associated with each of said extension classes, wherein each of the parent classes comprises a classed defined in the CIM Schema.

5. The method of claim 1, further comprising providing the revised CIM metadata file to a validation engine having access to information indicative of CIM extension classes indicated in the revised metadata file and CIM Schema classes, and generating a compliant/non compliant signal indicative of whether the CIM implementation is CIM compliant.

6. The method of claim 5, wherein generating said compliant/noncompliant signal includes determining, for an extension class indicated in the CIM metadata file, whether the indicated extension class is descended from a parent class that is defined in CIM Schema.

7. The method of claim 6, wherein generating said compliant/noncompliant signal further comprises determining for a property associated with an extension class, whether the property is defined by a parent class of the extension class and, if so, whether the parent class property and the extension class property have the same property type.

8. A computer application comprising instructions, stored on a computer readable medium, for verifying and maintaining compliance with a Common Information Model (CIM), the instructions comprising instructions for accessing an existing CIM metadata file and information indicative of a revised CIM Schema and instructions for using the accessed information to produce a revised CIM metadata file, wherein the revised CIM metadata file includes information indicative of CIM components associated with a CIM implementation.

9. The computer application of claim 8, wherein the CIM components include a specified version of a CIM Schema, a specified CIM provider, and a specified CIM profile.

10. The computer application of claim 9, wherein the CIM metadata file comprises an XML file.

11. The computer application of claim 10, wherein the CIM metadata file further includes information indicative of extension classes associated with the CIM implementation and parent classes associated with each of said extension classes, wherein each of the parent classes comprises a classed defined in the CIM Schema.

12. The computer application of claim 8, further comprising instructions for providing the revised CIM metadata file to a validation engine having access to information indicative of CIM extension classes indicated in the revised metadata file and CIM Schema classes, and instructions for generating a compliant/non compliant signal indicative of whether the CIM implementation is CIM compliant.

13. The computer application of claim 12, wherein instructions for generating said compliant/noncompliant signal includes instructions for determining, for an extension class indicated in the CIM metadata file, whether the indicated extension class is descended from a parent class that is defined in CIM Schema.

14. The computer application of claim 13, wherein instructions for generating said compliant/noncompliant signal further comprises instructions for determining for a property associated with an extension class, whether the property is defined by a parent class of the extension class and, if so, whether the parent class property and the extension class property have the same property type.

15. An information handling system including a CIM metadata file including information indicative of CIM components associated with a CIM implementation and an update engine configured to access an existing CIM metadata file and information indicative of a revised CIM Schema and to use the accessed information to produce a revised CIM metadata file, wherein the revised CIM metadata file includes information indicative of CIM components associated with a CIM implementation.

16. The information handling system of claim 15, wherein the CIM components include a specified version of a CIM Schema, a specified CIM provider, and a specified CIM profile and wherein the CIM metadata file comprises an XML file.

17. The information handling system of claim 16, wherein the CIM metadata file further includes information indicative of extension classes associated with the CIM implementation and parent classes associated with each of said extension classes, wherein each of the parent classes comprises a classed defined in the CIM Schema.

18. The information handling system of claim 15, further comprising a validate engine to provide the revised CIM metadata file to a validation engine having access to information indicative of CIM extension classes indicated in the revised metadata file and CIM Schema classes, and to generate a compliant/non compliant signal indicative of whether the CIM implementation is CIM compliant.

19. The information handling system of claim 18, wherein the validate engine determines, for an extension class indicated in the CIM metadata file, whether the indicated extension class is descended from a parent class that is defined in CIM Schema.

20. The information handling system of claim 19, wherein the validate engine determines, for a property associated with an extension class, whether the property is defined by a parent class of the extension class and, if so, whether the parent class property and the extension class property have the same property type.
